(19) United States
(12) Patent Application Publication
(10) Pub. No.: US 2019/0165358 A1
(43) Pub. Date: May 30, 2019

(54) DEVICE AND METHOD FOR PRODUCING ELECTRODE LAMINATE

(71) Applicant: TOYOTA JIDOSHA KABUSHIKI KAISHA, Toyota-shi (JP)

(72) Inventors: Kengo HAGA, Susono-shi (JP); Hideki ASADACHI, Toyota-shi (JP); Akiji HAYASHI, Toyota-shi (JP); Hiroyuki INOUE, Susono-shi (JP)

(21) Appl. No.: 16/149,662

(22) Filed: Oct. 2, 2018

(30) Foreign Application Priority Data
Nov. 24, 2017 (JP) 2017-226221

(51) Int. Cl. H01M 4/04; H01M 10/0562; H01M 10/052

(52) U.S. Cl. CPC H01M 4/0435; H01M 2300/0068; H01M 10/052; H01M 10/0562

(57) ABSTRACT

A device for producing an electrode laminate includes a roller configured to press an active material layer-attached current collector layer including a current collector layer and an active material layer disposed on at least one surface of the current collector layer. A diamond-like carbon film having an average roughness of 0.16 μm or less is on a surface of the roller in contact with an active material layer or a press sheet is disposed between the roller and a surface of the active material layer, and a diamond-like carbon film having an average roughness of 0.16 μm or less is on a surface of the press sheet in contact with the active material layer.

### INCORPORATION BY REFERENCE

The disclosure of Japanese Patent Application No. 2017-226221 filed on Nov. 24, 2017 including the specification, drawings and abstract is incorporated herein by reference in its entirety.

### BACKGROUND

### 1. Technical Field

The present disclosure relates to a device and method for producing an electrode laminate.

### 2. Description of Related Art

With the rapid spread of information related devices and communication devices such as computers, video cameras and cellular phones in recent years, the development of electrochemical elements of batteries used as power supplies thereof is considered to be important. In addition, the development of high output and high capacity batteries for electric vehicles and hybrid vehicles is also underway in the automobile industry and the like. Currently, among various batteries, lithium batteries have attracted much attention in consideration of their high energy density, and improvement in battery performance such as a higher output and a higher capacity is increasingly required.

Regarding a method for producing an electrode laminate having an active material layer containing an active material and a binder resin on at least one surface of a current collector layer, Japanese Unexamined Patent Application Publication No. 2014-102992 (JP 2014-102992 A) discloses pressing an active-material-layer-attached current collector layer in which an active material layer is applied to at least one surface of the current collector layer with a first roller disposed on one side of the current collector layer and a second roller disposed on the other side of the current collector layer.

In addition, Japanese Unexamined Patent Application Publication No. 10-012224 (JP 10-012224 A) discloses use of a roller core and a coating layer containing a ceramic material on a surface provided outside the roller core in order to reduce adhesion of an active material layer containing a positive electrode active material or a negative electrode active material to a surface of a roller during press rolling.

In addition, Japanese Unexamined Patent Application Publication No. 2015-178093 (JP 2015-178093 A) discloses that, in a production device that rolls a coating material containing a solvent using a roller and transfers the coating material to a coating target object, a surface of the roller is covered with a diamond-like carbon film.

### SUMMARY

When an active-material-layer-attached current collector layer including a current collector layer and an active material layer disposed on at least one surface of the current collector layer is pressed by a roller, there is a risk of materials constituting the active material layer adhering to the surface of the roller.

In the present disclosure, the following aspects are disclosed.

A first aspect of the present disclosure is a device for producing an electrode laminate, including a roller configured to press an active-material-layer-attached current collector layer including a current collector layer and an active material layer disposed on at least one surface of the current collector layer. The device includes a diamond-like carbon film having an average roughness of 0.16 μm or less. The diamond-like carbon film is on a surface of the roller in contact with the active material layer or a press sheet is disposed between the roller and the active material layer, and a diamond-like carbon film is on a surface of the press sheet in contact with the active material layer.

In the first aspect, a micro Vickers hardness Hv of the diamond-like carbon film may be 1,800 or more.

In the first aspect, a micro Vickers hardness Hv of the diamond-like carbon film may be 4,000 or less.

In the first aspect, a temperature of the surface of the roller may be within a range of 160° C. to 250° C.

In the first aspect, the roller may be configured that a linear pressure during pressing by the roller is within a range of 9 kN/cm to 60 kN/cm.

In the first aspect, a film containing metal nitride, chromium, silicon, or tungsten carbide may be provided between the diamond-like carbon film and the surface of the roller or the press sheet.

In the first aspect, the active material layer may include a sulfide solid electrolyte.

A second aspect of the present disclosure is a method for producing an electrode laminate, including pressing, by a roller, an active-material-layer-attached current collector layer including a current collector layer and an active material layer disposed on at least one surface of the current collector layer. A diamond-like carbon film having an average roughness of 0.16 μm or less is on a surface of the roller in contact with the active material layer, or, when a press sheet is disposed between the roller and the active material layer, a diamond-like carbon film having an average roughness of 0.16 μm or less is on a surface of the press sheet in contact with the active material layer.

In the second aspect, the active material layer may include a sulfide solid electrolyte.

According to the device and method of the present disclosure, when an active-material-layer-attached current collector layer including a current collector layer and an active material layer disposed on at least one surface of the current collector layer is pressed by a roller, it is possible to reduce adhesion of a material constituting the active material layer to the surface of the roller.

### BRIEF DESCRIPTION OF THE DRAWINGS

Features, advantages, and technical and industrial significance of exemplary embodiments of the disclosure will be described below with reference to the accompanying drawings, in which like numerals denote like elements, and wherein:

FIG. 1 is a schematic diagram for explaining an example of a state in which, in a device and method for producing an electrode laminate according to the present disclosure, an active-material-layer-attached current collector layer is pressed;

FIG. 2 is an enlarged view of an example of the active-material-layer-attached current collector layer to be pressed in the device and method for producing an electrode laminate according to the present disclosure; and

FIG. 3 is a schematic sectional view of an example of an all-solid-state lithium battery obtained using the active-material-layer-attached current collector layer produced in the device and method for producing an electrode laminate according to the present disclosure.

### DETAILED DESCRIPTION OF EMBODIMENTS

### <<Device and Method for Producing an Electrode Laminate>>

A device and method for producing an electrode laminate according to the present disclosure is a device and method for producing an electrode laminate in which an active-material-layer-attached current collector layer including a current collector layer and an active material layer disposed on at least one surface of the current collector layer is pressed by a roller. The roller has a diamond-like carbon film on its surface in contact with the active material layer, or, when a press sheet is disposed between the roller and the active material layer, the press sheet has a diamond-like carbon film on its surface in contact with the active material layer, and the average roughness Ra of the diamond-like carbon film is 0.16 μm or less.

According to the device and method of the present disclosure, when the active-material-layer-attached current collector layer including a current collector layer and an active material layer disposed on at least one surface of the current collector layer is directly pressed by a roller or indirectly pressed by a press sheet, it is possible to reduce adhesion of a material constituting the active material layer to the surface of the roller or the press sheet.

It is possible to reduce adhesion of an active material or a sulfide solid electrolyte to the surface of the roller or the press sheet. Therefore, it is thought that it is possible to reduce a reduction in weight per unit area of the active material layer due to adhesion of the active material layer to the roller or the press sheet, and/or it is possible to reduce the frequency of cleaning of the surface of the roller or the press sheet.

Here, in order to increase the energy density of the battery and increase the density of the active material layer, it is necessary to increase a linear pressure of the roller applied to the active-material-layer-attached current collector layer. It is assumed that, when the linear pressure during roll pressing increases, a tendency of the active material layer to adhere to the surface of the roller or the press sheet increases accordingly. Thus, the production device and method of the present disclosure are thought to be particularly useful when the linear pressure during roll pressing is high.

The diamond-like carbon film used in the device and method for producing an electrode laminate can be formed by, for example, a chemical vapor deposition (CVD) method, a physical vapor deposition (PVD) method, an ionized vapor deposition method, or the like.

### <Average Roughness Ra>

The average roughness Ra of the surface of the diamond-like carbon film may be 0.16 μm or less or 0.11 μm or less. In addition, the average roughness Ra of the surface of the diamond-like carbon film may be 0.01 μm or more or 0.11 μm or more. Here, a value calculated based on JIS Standard JISB0601:2001 can be used as the average roughness Ra.

The reason why adhesion of the active material layer to the surface of the roller or the press sheet is to be reduced when the average roughness Ra of the surface of the diamond-like carbon film is 0.16 μm or less is inferred as follows.

As shown in FIG. 2, there are irregularities on a surface of a diamond-like carbon film 8. It is inferred that, when the irregularities are large, that is, when the value of the average roughness Ra is large, materials contained in an active material layer 11, for example, an active material 15, a solid electrolyte 16, a conductive additive 17, and the like in the case of an all-solid-state battery, are caught on the irregularities, and these materials are adhered to the surface of the roller or the press sheet.

On the other hand, it is inferred that, when the average roughness Ra of the surface of the diamond-like carbon film 8 is small, that is, when there are small irregularities on the surface of the diamond-like carbon film 8 in contact with the active material layer 11, materials contained in the active material layer are not easily caught on the surface of the diamond-like carbon film, and adhesion of the materials to the surface of the roller or the press sheet can be reduced. Here, in the mode shown in FIG. 2, an intermediate layer 9 is formed on a base component 14 of the roller, and additionally, the diamond-like carbon film 8 is formed on the intermediate layer 9.

### <Micro Vickers Hardness Hv>

The micro Vickers hardness Hv of the surface of the diamond-like carbon film 8 may be 1,800 or more. It is inferred that, when the micro Vickers hardness Hv of the diamond-like carbon film 8 is sufficiently large, it is possible to reduce wear of the diamond-like carbon film when the electrode laminate is produced, materials contained in the active material layer in contact with the surface of the roller or the press sheet are not easily embedded in the roller or the press sheet, and adhesion of these materials to the roller can be reduced accordingly. Here, a value calculated based on JIS Standard JISZ2244 can be used as the micro Vickers hardness Hv.

The micro Vickers hardness Hv of the surface of the diamond-like carbon film 8 may be 1,800 or more, 1,850 or more, 1,900 or more, or 2,000 or more, and may be 4,010 or less, 4,000 or less, 3,000 or less, or 2,000 or less.

### <Pressing Pressure>

The linear pressure during pressing by the roller can be adjusted depending on, for example, a type of the active material layer to be pressed. For example, when an active material layer for an all-solid-state battery is pressed, the pressure may be 9 kN/cm or more, 10 kN/cm or more, or 20 kN/cm or more, and may be 60 kN/cm or less, 50 kN/cm or less, or 40 kN/cm or less.

### <Temperature of Pressing Surface>

The surface of the roller can be heated. For example, the temperature of the surface of the roller may be 150° C. or higher and 160° C. or higher and may be 300° C. or lower, 250° C. or lower, or 200° C. or lower. When the pressing surface of the roller is heated, the active material layer becomes dense, and crystallization of materials constituting the active material layer, for example, a solid electrolyte, is promoted, thereby contributing to improving the performance of the battery.

### <Configuration of Device for Producing Electrode Laminate>

The device and method for producing an electrode laminate according to the present disclosure will be described below with reference to the drawings. Here, in descriptions of the drawings, the same components are denoted with the same reference numerals and redundant descriptions thereof will be omitted.

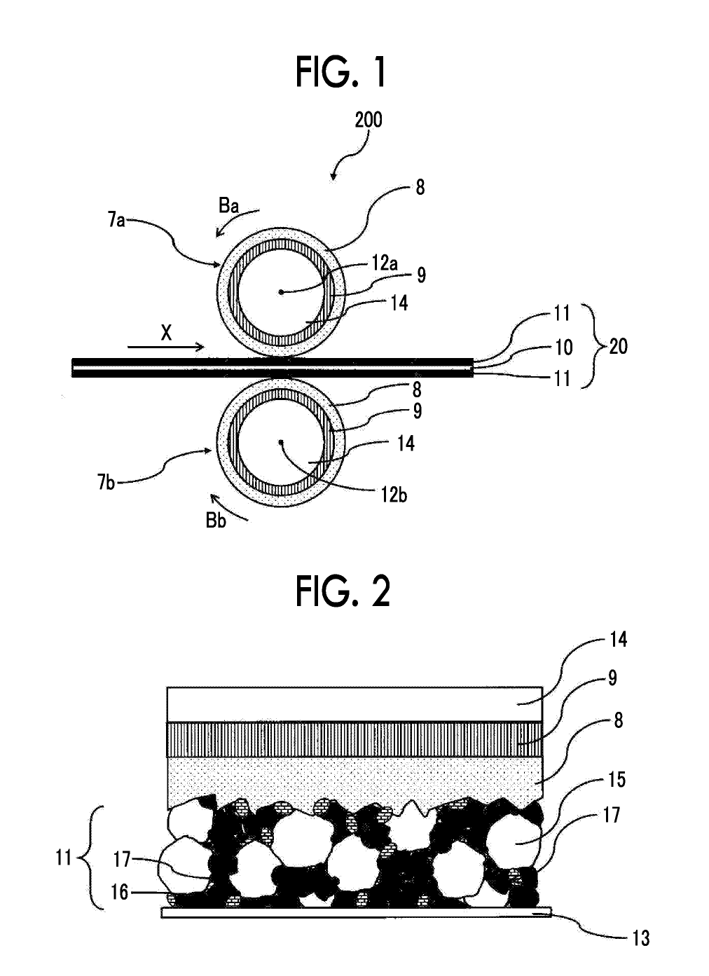

A device for producing an electrode laminate 200 will be described with reference to FIG. 1. In the following description, an active-material-layer-attached current collector layer 20 including a current collector layer 10 and the active material layer 11 disposed on at least one surface of the current collector layer is pressed. Here, in the present disclosure, this structure is called an active-material-layer-attached current collector layer before pressing and is called an electrode laminate after pressing.

The production device includes a first roller 7a that is disposed on one side of the active-material-layer-attached current collector layer 20 and a second roller 7b that faces the first roller 7a and is disposed on the other side of the active-material-layer-attached current collector layer 20. The first and second rollers 7a and 7b each have a cylindrical shape, and the base component 14 of the first and second rollers 7a and 7b is made of a metal, and particularly, is preferably made of carbon steel such as structural steel or tool steel having sufficiently high hardness. The diameters of the first and second rollers 7a and 7b can be substantially the same or different from each other.

The first and second rollers 7a and 7b are disposed at a predetermined interval, and press the active-material-layer-attached current collector layer 20 when the active-material-layer-attached current collector layer 20 is inserted between pressing surfaces. Here, for example, the first roller 7a is movable in a direction crossing a transport direction x of the active-material-layer-attached current collector layer 20 (for example, in the vertical direction) and the second roller 7b is fixed.

The first roller 7a and the second roller 7b are rotatable around rotation axes 12a and 12b. When the active-material-layer-attached current collector layer 20 is pressed, the first roller 7a rotates in a rotation direction indicated by an arrow Ba and the second roller 7b rotates in a rotation direction indicated by an arrow Bb, which is a direction opposite to that of the first roller 7a.

The first roller 7a and the second roller 7b can include a heating unit configured to heat a pressing surface. The heating unit is controlled by a control unit, heats all of the first and second rollers 7a and 7b, and thus can heat a pressing surface press-connected to the active-material-layer-attached current collector layer 20.

The first and second rollers 7a and 7b have the diamond-like carbon film 8 on their surfaces in contact with the active material layer 11. In addition, an intermediate film 9 may be provided between the diamond-like carbon film 8 and the surface of the base component 14 of the first and second rollers 7a and 7b. The intermediate film 9 is preferably made of a metal nitride such as titanium nitride, tantalum nitride, zirconium nitride, aluminum nitride, boron nitride, or chromium nitride, chromium, silicon, or tungsten carbide. In addition, these materials and surface treatments may be used alone or used in a mixture or combination as necessary. When the intermediate film is provided, peeling off of the diamond-like carbon film provided on the surface of the intermediate film from the roller can be particularly reduced during pressing.

Here, in the mode shown in FIG. 1, the first and second rollers 7a and 7b have the diamond-like carbon film 8 on their surfaces in contact with the active material layer 11. However, when a press sheet is disposed between the roller and the active material layer, the press sheet has a diamond-like carbon film on its surface in contact with the active material layer. In addition, in this case, since the first and second rollers 7a and 7b are not directly in contact with the active material layer, it is not necessary to provide the diamond-like carbon film 8 on these surfaces, and accordingly, the diamond-like carbon film 8 may not be provided on these surfaces. In addition, in this case, the intermediate film made of a metal nitride or the like may be provided between the diamond-like carbon film and the surface of the press sheet.

The press sheet may be an arbitrary sheet in which the active-material-layer-attached current collector layer can be pressed by the roller via the press sheet, and a sheet made of a metal, for example, stainless steel, can be used. If such a press sheet is used, when the pressing surface deteriorates, only the press sheet can be replaced without replacing the roller, which is preferable in consideration of production. In addition, the use of such a press sheet is preferable because it becomes easier to form the diamond-like carbon thereon compared to the use of the roller.

### <Battery Obtained Using Electrode Laminate>

An electrode laminate produced by the production device and method of the present disclosure may be applied to a battery other than the all-solid-state lithium battery. For example, the electrode laminate produced by the production device and method of the present disclosure may be applied to a lithium ion secondary battery using a separator and an electrolytic solution without a solid electrolyte, or may be applied to an electric double layer capacitor.

As described above, the electrode laminate produced by the production device and method of the present disclosure is not limited to the electrode laminate for an all-solid-state lithium battery. However, an all-solid-state lithium battery having an electrode laminate that can be produced by the production device and method of the present disclosure will be exemplified below.

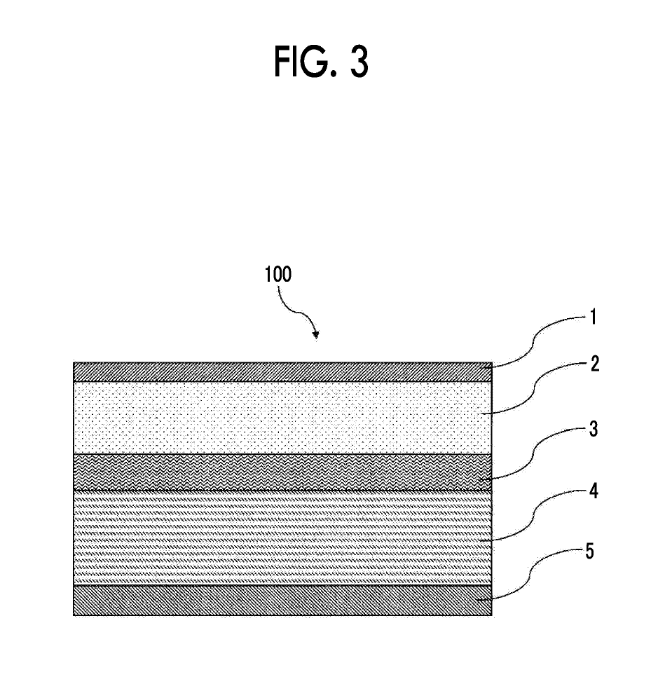

FIG. 3 is a schematic sectional view of an example of an all-solid-state lithium battery obtained using an electrode laminate that can be produced by the production device and method of the present disclosure. An all-solid-state lithium battery 100 shown in FIG. 3 includes a negative electrode current collector 1, a negative electrode active material layer 2, a solid electrolyte layer 3, a positive electrode active material layer 4 and a positive electrode current collector 5 in that order. Among them, a laminate of the negative electrode current collector 1 and the negative electrode active material layer 2 and/or a laminate of the positive electrode active material layer 4 and the positive electrode current collector 5 may be an electrode laminate that can be produced by the production device and method of the present disclosure.

### (Negative Electrode Current Collector)

The material of the negative electrode current collector is preferably a material that is not alloyed with Li, and examples thereof include SUS, copper, nickel, and carbon. Examples of the form of the negative electrode current collector include a foil form and a plate form. The shape of the negative electrode current collector in a plan view is not particularly limited, and examples thereof include a circular shape, an elliptical shape, a rectangular shape, and any polygonal shape. In addition, the thickness of the negative electrode current collector varies according to the shape, and is, for example, preferably in a range of 1 μm to 50 μm, and more preferably in a range of 5 μm to 20 μm.

### (Negative Electrode Active Material Layer)

The negative electrode active material layer is a layer that contains at least a negative electrode active material and may contain at least one of a conductive additive, a binder, and a solid electrolyte as necessary. Examples of the negative electrode active material include metal Li, a carbon material such as graphite and hard carbon, Si and a Si alloy, and Li₄Ti₅O₁₂. Although not particularly limited, the thickness of the negative electrode active material layer is, for example, 10 μm to 100 μm, and preferably 20 μm to 60 μm.

Examples of the conductive additive that can be contained in the negative electrode active material layer include acetylene black, Ketchen black, a carbon fiber, carbon nanotubes, and VGCF.

In addition, examples of the binder that can be contained in the negative electrode active material layer include a rubber type binder such as butylene rubber (BR), and styrene butadiene rubber (SBR) and a fluoride-based binder such as polyvinylidene fluoride (PVDF). In addition, the thickness of the negative electrode active material layer is preferably, for example, in a range of 0.1 μm to 1,000 μm.

The solid electrolyte that can be contained in the negative electrode active material layer is not particularly limited as long as it can be used for an all-solid-state lithium battery, and examples thereof include an inorganic solid electrolyte such as a sulfide solid electrolyte and an oxide solid electrolyte. Among them, the sulfide solid electrolyte is preferably used because it has high ionic conductivity.

Examples of the sulfide solid electrolyte include Li₂S—P₂S₅, Li₂S—P₂S₅—LiI, Li₂S—P₂S₅—LiI—LiBr, Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (here, m and n are positive numbers, and Z is any of Ge, Zn, and Ga), Li₂S—GeS₂, Li₂S—SiS₂—Li₃PO₄, and Li₂S—SiS₂-LiₓMO_{y} (here, x and y are positive numbers, and M is any of P, Si, Ge, B, Al, Ga, and In).

In addition, examples of the oxide solid electrolyte include Li₂O—B₂O₃—P₂O₃, Li₂O—SiO₂, Li₅La₃Ta₂O₁₂, Li₇La₃Zr₂O₁₂, Li₆BaLa₂Ta₂O₁₂, Li₃PO_{(4-3/2w)}N_{w}(w<1), and Li_{3.6}Si_{0.6}P_{0.4}O₄.

In addition, LiI, Li₃N and the like are exemplified. Here, the above term “Li₂S—P₂S₅” refers to a sulfide solid electrolyte obtained using a raw material composition containing Li₂S and P₂S₅ and this similarly applies to others terms.

In particular, the sulfide solid electrolyte preferably includes an ionic conductor containing Li, A (A is at least one of P, Si, Ge, Al and B), and S. In addition, the ionic conductor preferably includes an ortho compositional anionic structure (PS₄³⁻ structure, SiS₄⁴⁻ structure, GeS₄⁴⁻ structure, AlS₃³⁻ structure, BS₃³⁻ structure) as a main component of an anion. This is because the sulfide solid electrolyte having high chemical stability can be obtained. A proportion of the ortho compositional anionic structure is preferably 70 mol % or more and more preferably 90 mol % or more with respect to all anionic structures in the ionic conductor. A proportion of the ortho compositional anionic structure can be determined through Raman spectroscopy, NMR, XPS, or the like.

The sulfide solid electrolyte may include a lithium halide in addition to the ionic conductor. Examples of the lithium halide include LiF, LiCl, LiBr and LiI. Among them, LiCl, LiBr and LiI are preferable. A proportion of LiX (X═I, Cl, Br) in the sulfide solid electrolyte may be, for example, in a range of 5 mol % to 30 mol %, or in a range of 15 mol % to 25 mol %.

The solid electrolyte may be a crystalline material or an amorphous material. In addition, the solid electrolyte may be glass or crystallized glass (glass ceramics). Examples of the shape of the solid electrolyte include a particle form.

The average particle size (D₅₀) of the solid electrolyte is, for example, preferably in a range of 50 nm to 10 μm, and more preferably in a range of 100 nm to 5 μm. Here, a value calculated by a laser diffraction type particle size distribution meter or a value measured based on image analysis using an electron microscope such as an SEM can be used as the average particle size.

### (Solid Electrolyte Layer)

The solid electrolyte layer is a layer that contains at least a negative electrode active material, and a solid electrolyte that can be contained in the solid electrolyte layer can be contained in the above-described negative electrode active material layer.

### (Positive Electrode Active Material Layer)

The positive electrode active material layer is a layer that contains at least a positive electrode active material, and may contain at least one of a solid electrolyte, a conductive additive and a binder as necessary. The positive electrode active material generally contains Li. Examples of the positive electrode active material include an oxide active material, and specifically include a rock salt layered type active material such as LiCoO₂, LiMnO₂, LiNiO₂, LiVO₂, and LiNi_{1/3}Co_{1/3}Mn_{1/3}O₂, a spinel type active material such as LiMn₂O₄, and Li(Ni_{0.5}Mn_{1.5})O₄, and an olivine type active material such as LiCoPO₄, LiFePO₄, LiMnPO₄, LiNiPO₄, and LiCuPO₄. In addition, a Si-containing oxide such as Li₂FeSiO₄ and Li₂MnSiO₄ may be used as the positive electrode active material and a sulfide such as sulfur, Li₂S and lithium polysulphide may be used as the positive electrode active material.

The average particle size (D₅₀) of the positive electrode active material is, for example, preferably in a range of 10 nm to 50 μm and more preferably in a range of 100 nm to 10 μm, and most preferably in a range of 1 μm to 20 μm. Here, a value calculated by a laser diffraction type particle size distribution meter or a value measured based on image analysis using an electron microscope such as an SEM can be used as the average particle size.

In addition, a coating layer containing a Li ion conductive oxide may be formed on the surface of the positive electrode active material. This is because the reaction between the positive electrode active material and the solid electrolyte can be reduced. Examples of the Li ion conductive oxide include LiNbO₃, Li₄Ti₅O₁₂, and Li₃PO₄. The thickness of the coating layer may be, for example, in a range of 0.1 nm to 100 nm or in a range of 1 nm to 20 nm. The coverage of the coating layer on the surface of the positive electrode active material may be, for example, 50% or more or 80% or more.

The solid electrolyte that can be contained in the positive electrode active material layer can be contained in the above-described negative electrode active material layer.

Examples of the conductive additive and binder that can be contained in the positive electrode active material layer include the same materials as the conductive additive and binder that can be contained in the above-described negative electrode active material layer. The thickness of the positive electrode active material layer is, for example, preferably in a range of 0.1 μm to 1,000 μm.

### (Positive Electrode Current Collector)

Examples of the material of the positive electrode current collector include SUS, aluminum, nickel, iron, titanium, and carbon. Preferably, the thickness, the shape, and the like of the positive electrode current collector can be appropriately selected according to an application of the battery and the like. In addition, the thickness of the positive electrode current collector varies according to the shape, and is, for example, preferably in a range of 1 μm to 50 μm, and more preferably in a range of 5 μm to 20 μm.

Here, the present disclosure is not limited to the embodiment. The embodiment is only an example, and anything having substantially the same configuration as in the technical idea described in the scope of the claims in the present disclosure and having the same operations and effects is included in the technical scope of the present disclosure.

The present disclosure will be described below in more detail with reference to examples.

### Example 1

A diamond-like carbon (DLC) film with a thickness of about 2.5 μm was formed on a surface of an SUS304 sheet with a thickness of 50 μm by a plasma CVD method and thereby an SUS sheet used as a press sheet in Example 1 was obtained.

### (Preparation of Positive Electrode Composite Paste)

A butyl butyrate solution containing butyl butyrate as a dispersion medium and 5 wt % of a PVDF-based binder as a binder, LiNi_{1/3}Co_{1/3}Mn_{1/3}O₂ (commercially available from Nichia Corporation) as a positive electrode active material, a Li₂S—P₂S₅—LiI-based glass ceramic as a solid electrolyte, and VGCF (commercially available from Showa Denko) as a conductive additive were put into a container, and stirring was performed using a Filmix dispersing device, and thereby a positive electrode composite paste was obtained.

### (Film Formation of Positive Electrode)

The positive electrode composite paste was applied to an aluminum foil as a positive electrode current collector by a blade method and dried on a hot plate at 100° C. for 30 minutes, and a positive electrode active material layer was formed into a film formation, and thereby a positive electrode active material layer-attached current collector layer was obtained.

### (Roll Pressing of Positive Electrode)

A surface of the SUS sheet on which a diamond-like carbon film was formed was disposed to face the formed positive electrode active material layer. Then, the SUS sheet and the positive electrode were heated at 170° C. and subjected to hot roll pressing.

### Example 2

The same positive electrode active material layer as in Example 1 was subjected to hot roll pressing under the same conditions as in Example 1 except that a diamond-like carbon film with a thickness of about 2 μm was formed on a surface of an SUS304 sheet with a thickness of 50 μm by a plasma CVD method with a different source gas composition.

### Comparative Example 1

The same positive electrode active material layer as in Example 1 was subjected to hot roll pressing under the same conditions as in Example 1 except that a surface of an SUS304 sheet with a thickness of 50 μm was not subjected to a film formation treatment.

### Comparative Example 2

The same positive electrode active material layer as in Example 1 was subjected to hot roll pressing under the same conditions as in Example 1 except that a surface of an SUS304 sheet with a thickness of 50 μm was treated with a hard chromium plating with a film thickness of about 80 μm.

### Comparative Example 3

The same positive electrode active material layer as in Example 1 was subjected to hot roll pressing under the same conditions as in Example 1 except that a diamond-like carbon film with a thickness of about 1 μm was formed on a surface of an SUS304 sheet with a thickness of 50 μm by a physical vapor deposition (PVD) method.

### [Evaluation]

### (Method of Measuring Average Roughness Ra of Film Formed on Surface of SUS Sheet)

The average roughness Ra of the film formed on the surface of the SUS sheet was measured using a shape measurement laser microscope (VK-X200 commercially available from Keyence Corporation) based on JISB0601:2001.

### (Method of Measuring Micro Vickers Hardness Hv of Film Formed on Surface of SUS Sheet)

The micro Vickers hardness Hv of the film formed on the surface of the SUS sheet based on JISZ2244 was measured.

### (Measurement of Amount Adhered to Surface of SUS Sheet)

SEM images were acquired at a magnification of 1000 from the surface of the SUS sheet in contact with the positive electrode active material layer in hot roll pressing using a field emission scanning electron microscope (SU8030 commercially available from Hitachi High-Technologies Corporation) into which an energy dispersive X-ray analyzer (Quantax400 commercially available from Bruker) was built and were subjected to EDX plane analysis. A molar ratio between sulfur (S) derived from the solid electrolyte and nickel (Ni) derived from the positive electrode active material was acquired, and an adhesion amount was measured.

Adhesion amounts (at %) of sulfur and nickel of Example 1 and Example 2, and Comparative Example 1 to Comparative Example 3 are shown in Table 1. Table 1 shows the type of the film formed on the surface of the SUS sheet, the average roughness Ra, the micro Vickers hardness Hv, the adhesion amount (at %) of sulfur (S), and the adhesion amount (at %) of nickel (Ni) in examples and comparative examples.

TABLE 1

| | | | Micro | | |
|---|---|---|---|---|---|
| | | Average | Vickers | | |
| | Type | roughness | hardness | Adhesion amount | |
| | of film | Ra (μm) | Hv | S (at %) | Ni (at %) |
| Comparative | None | 0.34 | 400 | 8.22 | 4.72 |
| Example 1 | | | | | |
| Comparative | Hard | 0.18 | 800 | 0.75 | 0.16 |
| Example 2 | chromium | | | | |
| Comparative | DLC | 0.95 | 4,010 | 0.53 | 0.06 |
| Example 3 | | | | | |
| Example 1 | DLC | 0.11 | 1,800 | 0.01 | Detection |
| | | | | | limit or less |
| Example 2 | DLC | 0.16 | 1,850 | 0.07 | 0.05 |

Based on the results, it can be understood that, when the diamond-like carbon (DLC) film was formed, the hardness of the film was higher than when there was no film and when a hard chromium film was formed. In addition, the average roughness Ra differed even in the DLC film depending on a film formation method.

It can be understood from Table 1 that, comparing Example 1 and Example 2 and Comparative Example 1 to Comparative Example 3, when the diamond-like carbon (DLC) film was formed on the surface of the SUS sheet and the average roughness Ra of the film formed on the surface of the SUS sheet was 0.16 μm or less, adhesion of sulfur to the surface of the SUS sheet in contact with the positive electrode active material layer was reduced. Accordingly, it can be understood that, when the average roughness Ra of the diamond-like carbon (DLC) film formed on the surface of the SUS sheet was 0.16 μm or less, adhesion of the material contained in the active material layer was further reduced.

In Table 1, comparing Example 1 and Example 2 and Comparative Example 1 and Comparative Example 2, when the micro Vickers hardness Hv of the film formed on the surface of the press sheet (SUS sheet) was 1,800 or more, adhesion of nickel derived from the positive electrode active material was reduced. Accordingly, it was thought that, when a film having a micro Vickers hardness Hv of 1,800 or more was formed on the press sheet or the roller, the positive electrode active material having a relatively high hardness was reduced from embedding into and adhering to the press sheet or the roller.

What is claimed is:

1. A device for producing an electrode laminate, comprising:
a roller configured to press an active-material-layer-attached current collector layer including a current collector layer and an active material layer disposed on at least one surface of the current collector layer; and
a diamond-like carbon film having an average roughness of 0.16 μm or less
wherein the diamond-like carbon film is on a surface of the roller in contact with the active material layer, or
a press sheet is disposed between the roller and a surface of the active material layer, and the diamond-like carbon film is on a surface of the press sheet in contact with the active material layer.

2. The device according to claim 1, wherein a micro Vickers hardness of the diamond-like carbon film is 1,800 or more.

3. The device according to claim 1, wherein a micro Vickers hardness of the diamond-like carbon film is 4,000 or less.

4. The device according to claim 1, wherein a temperature of the surface of the roller is within a range of 160° C. to 250° C.

5. The device according to claim 1, wherein the roller is configured that a linear pressure during pressing by the roller is within a range of 9 kN/cm to 60 kN/cm.

6. The device according to claim 1, further comprising a film containing a metal nitride, chromium, silicon, or tungsten carbide is provided between the diamond-like carbon film and the surface of the roller or the press sheet.

7. The device according to claim 1, wherein the active material layer includes a sulfide solid electrolyte.

8. A method for producing an electrode laminate, comprising:
pressing, by a roller, an active-material-layer-attached current collector layer including a current collector layer and an active material layer disposed on at least one surface of the current collector layer,
wherein a diamond-like carbon film having an average roughness of 0.16 μm or less is on a surface of the roller in contact with the active material layer, or
a press sheet is disposed between the roller and a surface of the active material layer, and a diamond-like carbon film having an average roughness of 0.16 μm or less is on a surface of the press sheet in contact with the active material layer.

9. The method according to claim 8, wherein the active material layer includes a sulfide solid electrolyte.
